(19) United States
(12) Patent Application Publication
(10) Pub. No.: US 2007/0094249 A1
(43) Pub. Date: Apr. 26, 2007

(54) Database creation by searching the web for enumerations

(75) Inventors: Johannes Henricus Maria Korst, Eindhoven (NL); Nicolas De Jong, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/570,545

(22) PCT Filed: Aug. 26, 2004
(86) PCT No.: PCT/IB04/51577

§ 371 Date: Mar. 3, 2006

(30) Foreign Application Priority Data
Sep. 12, 2003 (EP) 03103363.2

(51) Int. Cl. G06F 17/30

(52) U.S. Cl. 707/5

(57) ABSTRACT

The invention exploits the overlap between enumerations or listings that are present in electronic documents of a large collection in order to create or extend a database.

### FIELD OF THE INVETION

The invention relates to a method of enabling to extend a set of information items, to a method of extending a set of information items and to software for carrying out the methods.

### BACKGROUND ART

The term “ontology”, as used in a computational environment, typically refers to the specification of term names, term meanings, and interrelations of the terms. Ontologies, also referred to as “domain conceptualizations”, resemble taxonomies but may use richer semantic relationships among terms, as well as strict rules about how to specify terms and relationships. See, e.g., Deborah L. McGuinness. “Ontologies Come of Age”. In Dieter Fensel, Jim Hendler, Henry Lieberman, and Wolfgang Wahlster, editors. Spinning the Semantic Web: Bringing the World Wide Web to Its Full Potential. MIT Press, 2002.

The creation of an ontology is typically a time-consuming task. At Yahoo, for example, a small group of experts categorize Web pages manually. The Open Directory Project (ODP) of DMOZ leverages the collaborative effort of over 35,000 volunteer editors to generate large, simple ontologies, with over 360,000 classes in a taxonomy.

### SUMMARY OF THE INVENTION

The inventors consider as an example the metadata accompanying electronic content information available on the Internet, and on carriers such as optical disks, memory cards, etc. Metadata is additional information that can be used to search or browse audio/video content. For example, the metadata relating to a song can include the title of the song, the names of the artists, an indication of the genre, etc. Given an ontology of a certain domain (pop-music, movies, etc.), it is often difficult to fill the metadata database with relevant data. To fill the database by manually adding the data is expensive and time-consuming. The inventors therefore propose to automatically fill the database, by using information that is available on web pages of the world-wide web. The idea is to automatically extend a small set of items of a given type by searching on web pages for enumerations, in which multiple items of the given set are listed. With high probability the other words (or word combinations) in such enumerations will also refer to items of the same type. The invention thus exploits the overlap between enumerations or listings that are present in electronic documents of a large collection in order to create or extend a database.

More specifically, an instantiation of the invention relates to a method of enabling to extend a set of information items that have an ontological attribute in common. The method comprises enabling to query a collection of electronic documents about a first enumeration of multiple items of the set. The query is run on, e.g., the world-wide-web with any convenient search engine such as Google, or on any other collection of electronic documents that can be subjected to, e.g., a full-text search. In respective ones of the documents represented in a query result of the query, a respective candidate item is identified in a respective second enumeration comprising the first enumeration. Then it is determined if among the respective candidate items there is a specific item having the attribute in common with the items of the set If the specific item is determined to have the attribute in common, and is not already comprised in the set, the specific item is provided for being added to the set. Determining whether or not this commonality is present comprises, for example, determining a number of times that the candidate item co-occurs with those of the first enumeration and/or with another enumeration of different items of the set. For example, the determining comprises evaluating a number of documents in the query result that contain the same respective candidate item. The method of the invention may go through two or more further iterations. The collection is then further queried about a third enumeration of a plurality of items of the set, wherein the third enumeration is different from the first enumeration. For example, the third enumeration comprises a permutation of the first enumeration, or the third and first enumeration differ from one another by at least one item, e.g., the third enumeration comprises the specific item found in the previous enumeration, etc.

The method of enabling as defined above is carried out by, e.g., the server of a provider of information services on the Internet, e.g., as an extension to existing search engines.

Another instantiation of the invention relates to a method of extending a set of information items that have an ontological attribute in common. The method comprises: querying on a collection of electronic documents about a first enumeration of multiple items of the set; identifying in respective ones of the documents represented in a result of the query a respective candidate item in a respective second enumeration comprising the first enumeration; determining if among the respective candidate items there is a specific item having the attribute in common with the items of the set; and, if the specific item is determined to have the attribute in common and is not already comprised in the set, adding the specific item to the set. This instantiation of the invention is carried by a database provider or database creator using software to automatically create a database or ontology.

The invention thus exploits the overlap between enumerations or listings that are present in electronic documents of a large collection of documents in order to create or extend a database.

### BRIEF DESCRIPTION OF THE DRAWING

The invention is explained in further detail, by way of example and with reference to the accompanying drawing wherein:

FIG. 1 is a flow diagram of a method in the invention;

FIG. 2 is block diagram of a system in the invention; and

FIG. 3 is an illustration of some process steps in the method of FIG. 1.

Throughout the figures, same reference numerals indicate similar or corresponding features.

### DETAILED EMBODIMENTS

The invention relates to extending a collection of items of a given type with additional items of that same type by means of searching the Web for enumerations wherein multiple given items co-occur. The invention is based on the assumption that in an enumeration or list of specific items found on a web page, more items of the same type are present. By counting the number of times that a co-occurring item is present together with the enumeration with the given multiple items, items can be filtered that are unlikely to be of the proper type. In addition, by counting the relative frequency of hits for different enumerations with given items, more unlikely items newly found are filtered out. A next iteration then may use a next enumeration to start the querying with one or more new items found in the previous iteration. By means of presenting a search program with only a few items to start with, a database can be built with many more items found in a number of iterations.

An item consists of, e.g., a single word or name, or is a composite entity consisting of multiple words in a specific order. The search program may search documents in only a particular language owing to the spelling used. A translation of the initial items into another language may turn up additional items not found or originally not accepted using the initial language. Another fine-tuning of the search relates to running the query using an ordering or arrangement of the initial items that are entered in a specific sequence. For example, information items known in advance of the set to be extended are arranged alphabetically or in order of increasing or decreasing magnitude or size of their concepts covered, etc.

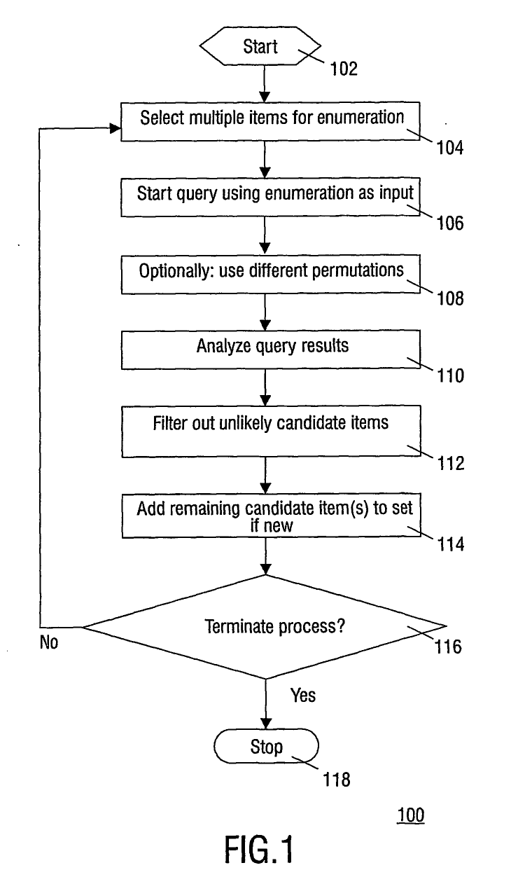

FIG. 1 is a flow diagram of a method in the invention. A step 102 starts the process with one or more known information items of a set that the user seeks to extend by adding new similar information items. For example, assume that the user wants to create a database about composers and their music. Relevant information items are then the names of the composers and the names or other identifiers of their creations. Assume that the user selects as initial items the family names of three composers: Beethoven, Bach, and Mozart. In a step 104, the user prepares this first enumeration as a text string “Bach, Mozart, Beethoven”. In a step 106, this first enumeration is entered into a search engine running a query on a collection of electronic documents, e.g., the world-wide-web. In a step 108, additional queries are run, e.g., as an option, using different permutations of the first enumeration. Different permutations result in different query results. In a step 110 the query results are analyzed. For example, one keeps a score of the number of electronic documents that contains a specific new candidate item co-occurring in a second enumeration containing the first enumeration or any permutation thereof. A second enumeration then comprises the first enumeration (or permutation thereof) between two new candidate items or flanked by a single candidate item at the right hand side or the left hand side. It is likely that the number of documents found for which the second enumeration contains, e.g., “Overtures” or “prefer” is lower than the number of documents found, for which the second enumeration contains e.g., “Chopin” or “Haydn”. Additional filtering out of unlikely candidates may use determining the relative frequency of hits among the documents in the query results for different subsets (further enumerations) containing two or more new candidates found. Alternatively, or in addition, additional filtering uses running an additional query per candidate item in combination with a specifier of the ontological type searched for. In above example, one may run a query on “composer Haydn” and/or “Haydn, composer” and/or “Haydn's music”, etc. In a step 112 the unlikely candidate items are purged and in a step 114, the remaining new 30 candidates are added to the set if they are not already elements of the set. In a step 116, it is decided whether the process proceeds to a step 118 so as to be terminated or if the process continues. If the process continues, it returns to step 104 for a next iteration wherein a new multiple of items is selected from the current set.

In an iteration that is not the first, the analyzing in step 110 may also include correlating the current results with those of previous iterations, e.g, by analyzing the scores accumulated over the iterations carried out so far. In addition, one may also keep track of which specific electronic documents turn up in two or more iterations. These specific documents then may already contain a larger listing of the items sought. For example, if the same document has appeared among the query results for, e.g., more than half of all iterations so far, one may consider scanning this document in a broader scope, e.g., by iteratively testing if the neighbor of an accepted candidate item in the second enumeration contained in this specific document, the neighbor not being present in the first enumeration, also has a high degree of occurrence in the other documents retrieved so far. If so, then this neighbor is likely to be an acceptable candidate as well. The process then can proceed by evaluating the neighbor's neighbor, etc.

Further, before terminating the process in step 118 an optional step (not shown) can be carried out to further purify the set thus extended. For example, if there is a large difference between the number of documents that include a certain item and the number of documents that include any other item, one may consider the certain item an anomaly and delete it from the set. Statistical analysis, user intervention or editor intervention may be needed for this step.

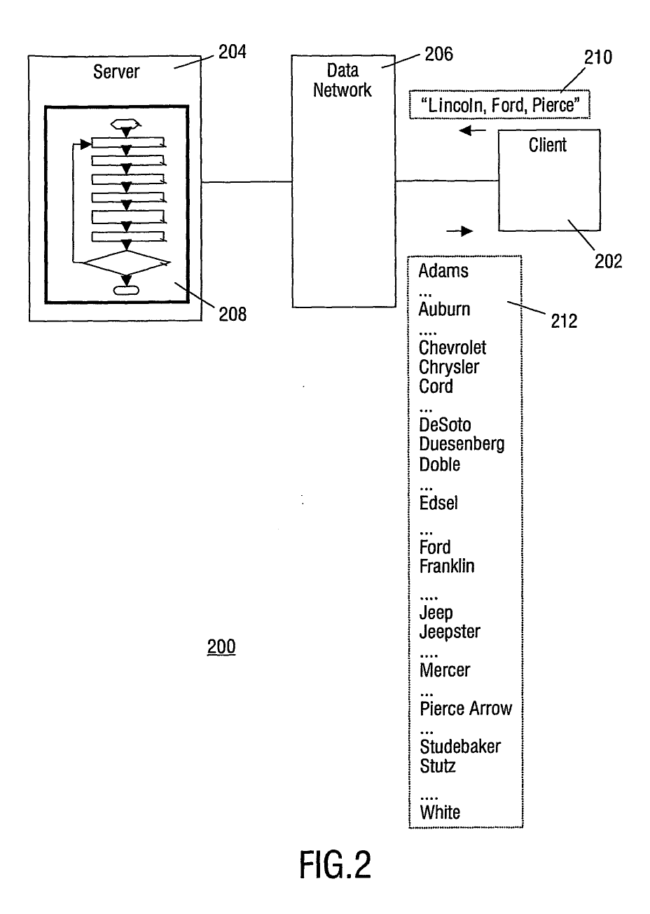

FIG. 2 illustrates further aspects of the invention with reference to a client-server system 200 with a client 202 connected to a server 204 via a data network 206. Server 204 has got application software 208 implementing the method illustrated with reference to the flow diagram of FIG. 1. The user of client 202 would like to have a listing of certain items and contacts server 204. The user provides to server 204 the initial enumeration “Ford, Lincoln, Pierce” with reference numeral 210. Following the method outlined in flow diagram 100, the server may find that the automatic search results appear to be concentrated in two practically disjoint topical sets of documents. Closer inspection reveals that one set of documents relates to “American Presidents”. A complete list of US presidents includes the family names of Gerald Ford, Abraham Lincoln and of Franklin Pierce (and of John Adams and of John Quincy Adams, the son of the former Adams). The other set relates to “American classic or vintage automobiles”, a complete list of which comprises “Ford”, “Lincoln”, “Pierce Arrow”, (and “Franklin” and “Adams” as well). As a detail: the make “Lincoln” is owned by Ford so that strictly speaking “Lincoln” should be a subordinate or subset of “Ford” from the purist's point of view. The bifurcation (“Presidents” and “cars”) can be resolved in various manners. For example, server 204 may request additional information input from the user such as an additional item (“Jeep”), or a topical aspect of the query (“cars”). Server 204 may alternatively take into account a context, a user profile or interaction history. See, e.g., U.S. patent U.S. patent 6,256,633 (attorney docket PHA 23,422) incorporated herein by reference and briefly discussed below. As yet another solution, server 204 forms a gateway to a (real or virtual) network of further servers that have organized their document inventory according to topics. The user is required to make a category selection prior to initiating the query. Within this context see, e.g., U.S. Pat. No. 6,349,307 (attorney docket PHA 23,606) incorporated herein by reference and briefly discussed below. Assume that the ambiguity has been resolved and that the user was interested in a listing of American classic automobiles. Server 204 runs software application 208 using one or more iterations and returns a listing 212 of automobile makes. Listing 212 may comprise as an option a respective pointer to respective further documents per respective one of the items in listing 212. For example, the pointer associated with the entry “Doble” refers to query results of a conventional search engine on the input “Doble AND (automobile OR car)” the terms in capital letters indicating relevant Boolean operators.

Once a listing is accepted as complete and process 100 is terminated the result is a database with a one-dimensional array of information items, possibly accompanied by meta-information using pointers as mentioned above. The database can be expanded so as to be represented by a two- or more dimensional array. For example, the user in the example under FIG. 2 may want to find different models per make as listed. For example, the user enters the string “Model A, Model T, Thunderbird”, and preferably “AND Ford”. Process 100 returns eventually a listing of models of the Ford brand, including the three initial ones plus the Model K, the Fordor and Tudor, the F1 pickup, the Mustang, etc., etc. For each of the items in the original listing (the brands) the user is to initialize the expansion to a further dimension of listings by entering some items known in advance as belonging to the further dimension (here: the models manufactured by Ford).

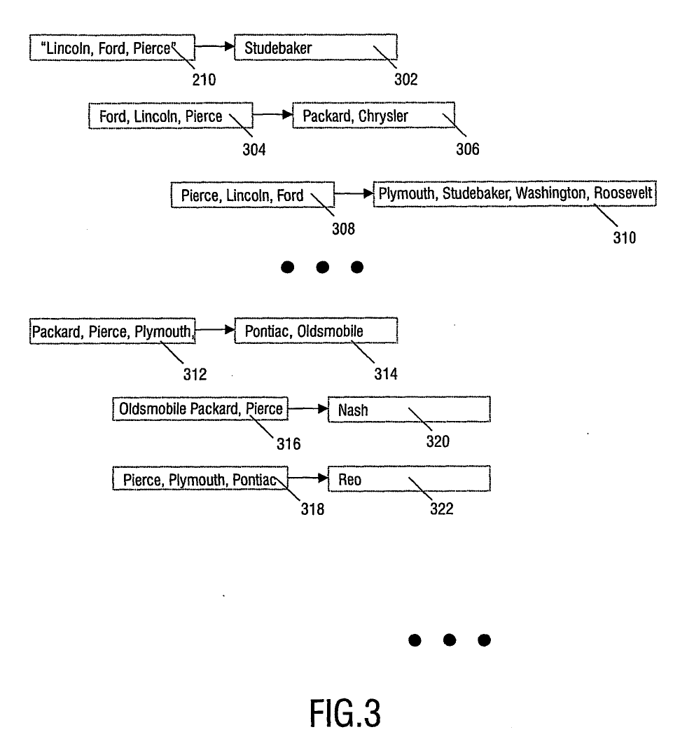

FIG. 3 illustrates some of the aspects touched upon under FIGS. 1 and 2. As mentioned, the user provides as an entry the enumeration 210 “Lincoln, Ford, Pierce” and intends to create a database about American classic cars. System 200 receives entry 210 and retrieves as a query result a document that comprises an enumeration “Studebaker, Lincoln, Ford, Pierce Arrow, Duesenberg”. The term “Studebaker” is therefore a candidate 302 for being added to the set. The term “Duesenberg” is not identified as a candidate as it does not immediately follow “Pierce” in the listing found. System 200 then runs queries about various permutations of enumeration 210. A permutation 304 “Ford, Lincoln, Pierce” results in a document with a listing “Packard, Lincoln, Ford, Pierce, Chrysler” and therefore leads to additional candidates 306 “Packard” and “Chrysler”. A permutation 308 “Pierce, Lincoln, Ford” returns documents from which additional candidates 310 are retrieved as “Plymouth”, “Studebaker”, “Washington”, and “Roosevelt”. The term “Studebaker” was already identified as a candidate. The terms “Roosevelt” and “Washington” are at this point legitimate candidates and will in further iterations lead, together with “Lincoln”, “Ford” and “Pierce”, to further legitimate candidates that represent the names of American presidents. Accordingly, the documents in the cumulative search results will eventually appear to form a cluster relating to automobiles and another cluster relating to American presidents, the clusters having an insignificant overlap, if any. Therefore, the terms that have arisen out of the presidential document cluster have to be correlated with the terms from the automobile document cluster. The terms that do NOT appear in both clusters are then to be deleted from the list of new terms to be added to the database. Alternatively, the clusters' documents are scanned for the string “automobile” and those that do not contain this string are discarded together with the candidate terms stemming from these documents from which “automobile” is absent. In a further iteration, system 200 may select an entry 312 as “Packard, Pierce, Plymouth” when it returns to step 104. Note that the terms all start with the same letter and are presented in alphabetical order, rather than in random order. This increases the chance of finding a document with a more or less complete listing of more car makes, as such a listing is likely to have been arranged alphabetically. Entry 312 leads to candidates 314 “Pontiac” and “Oldsmobile” that are likely to have arisen from an enumeration “Oldsmobile, Packard, Pierce, Plymouth, Pontiac”. As to alphabetically ordered items for entry to the query, system 200 preferably queries the documents about further enumerations 316 and 318 that consist of the truncated previous enumeration 312 and a respective new candidate (“Oldsmobile” and “Pontiac”) added in the respective alphabetically correct position. If the same document that gave rise to result 314 also produces legitimate new candidates 320 and 322, here “Nash” and “Reo”, system 200 may subject the same document to further iterations repeatedly using the truncate-and-add steps.

An interesting use of the method in the invention relates to finding translations of particular words in another language. Consider for example the name of a city in different languages, e.g., the words “Milano”, “Milan”, “Mailand”, “Milaan” all refer to the same city in northern Italy in Italian, French/English, German and Dutch, respectively. The spelling of the name of the capital of the Netherlands, “Amsterdam”, is conserved when translated to most other languages. This means that the items in an enumeration of names of cities as obtained in a method of the invention depend on the language wherein the documents analyzed have been worded. Accordingly, one could start a query with a first enumeration of names that are language independent, the query being restricted to documents in a specific language. For example, the method of the invention applied to the enumeration “Amsterdam, Rotterdam, Utrecht” and restricted to documents in English will probably result in candidate items as “Eindhoven” and “The Hague”. A similar query restricted to documents in the French language will probably have among the results “Eindhoven” and “La Haye”, whereas one limited to Dutch documents will lead to “Eindhoven” and “'s Gravenhage” and “Den Haag”. Analyzing the eventual results of the queries in different languages will lead to the insight that the terms “The Hague”, “La Haye”, “Den Haag” and “'s Gravenhage” all refer to the same Dutch city in the west of the Netherlands, and that “Den Bosch” “s Hertogenbosch” and “Bois-le-Duc” are different names for the same Dutch city in the south, the first two in the Dutch language and the last one in French. Note that analyzing the eventual enumerations may therefore also leads to alternative indications, e.g., “Holland”, “The Netherlands”, and “The Low Countries”, of the same entity in the same language.

Incorporated herein by reference are the following:

U.S. Pat. No. 6,349,307 (attorney docket PHA 23,606) issued to Doreen Cheng for COOPERATIVE TOPICAL SERVERS WITH AUTOMATIC PREFILTERING AND ROUTING. This patent relates to an information organization and retrieval system that efficiently organizes documents for rapid and efficient search and retrieval based upon topical content The information organization and retrieval system is optimized for the organization and retrieval of only those documents that are relevant to a given set of predefined topics. If a document does not have a topic that is included in the given set of topics, the document is excluded from the provided service. In like manner, if a document includes a topic that is specifically banned from the provided service, it is excluded. In this paradigm, the provider purposely limits the scope of the provided search and retrieval services, but in so doing provides a more efficient and effective service that is targeted to an expected user demand. The information organization and retrieval system also supports context-sensitive search and retrieval techniques, including the use of predefined or user-defined views for augmenting the search criteria, as well as the use of user-specific vocabularies. In a preferred embodiment, the select set of topics are organized in multiple overlapping hierarchies, and a distributed software architecture is used to support the topic-based information organization, routing, and retrieval services. Documents may be relevant to one or more topics, and will be associated with each topic via the topical hierarchies that are maintained by the information servers.

U.S. Pat. No. 6,256,633 (attorney docket PHA 23,422) issued to Chanda Dharap for CONTEXT-BASED AND USER-PROFILE DRIVEN INFORMATION RETRIEVAL This patent relates to enabling a user to navigate through an electronic data base in a personalized manner. A context is created based on a profile of the user, the profile being at least partly formed in advance. Candidate data is selected from the data base under control of the context and the user is enabled to interact with the candidates. The profile is based on topical information supplied by the user in advance and a history of previous accesses from the user to the database. This patented invention increases the effectiveness of browsing wide-area information by means of focusing primarily on the user's interest as given by the user's access history in terms of the results of previous queries. Taking these results into account for next queries creates a context that enables interpreting the current query object in view of what currently is likely to be of interest to this specific user. The context for the current query is used to update the user's profile. The profile itself is used as a recommendation for mapping relevant information form the information provider's topic space, also referred to as document base, onto the user's search space. The profile gets updated dynamically in response to the user's interactions with the document base. Accordingly, the dynamic part reflects the path taken within the provider's information space in the course of the user's search. Preferably, the profile has also a static part that reflects the user's long-term interests. The term “static” is used to indicate a time scale substantially slower than that of the dynamic part. The static part is determined by, for example, letting the user provide topical information about his/her fields of attention the first time that the user interacts with the document base. Such entries can be changed manually in due course. Alternatively, or in addition, statistical analysis of a statistically relevant number of results over time enables finding themes that stay substantially constant.

1. A method of enabling to extend a set of information items that have an ontological attribute in common, the method comprising:
enabling to query a collection of electronic documents about a first enumeration with multiple items of the set;
identifying in respective ones of the documents represented in a result of the query a respective candidate item in a respective second enumeration comprising the first enumeration;
determining if among the respective candidate items there is a specific item having the attribute in common with the items of the set; and
if the specific item is determined to have the attribute in common and is not already comprised in the set, providing the specific item for being added to the set.

2. The method of claim 1, wherein the determining comprises evaluating a number of documents in the query result that contain the respective candidate item.

3. The method of claim 1, comprising further querying the collection about a third enumeration of a plurality of items of the set, the third enumeration being different from the first enumeration.

4. The method of claim 3, wherein the third enumeration comprises a permutation of the first enumeration.

5. The method of claim 3, wherein the third enumeration differs from the first enumeration by at least one item.

6. The method of claim 3, wherein the third enumeration comprises the specific item.

7. The method of claim 1, wherein the enabling to query comprises restricting the collection to the documents in a particular language.

8. A method of extending a set of information items that have an ontological attribute in common, the method comprising:
querying on a collection of electronic documents about a first enumeration of multiple items of the set;
identifying in respective ones of the documents represented in a result of the query a respective candidate item in a respective second enumeration comprising the first enumeration;
determining if among the respective candidate items there is a specific item having the attribute in common with the items of the set; and
if the specific item is determined to have the attribute in common and is not already comprised in the set, adding the specific item to the set.

9. The method of claim 8, wherein the determining comprises evaluating a number of documents in the query result that contain the respective candidate item.

10. The method of claim 8, comprising further querying the collection about a third enumeration of a plurality of items of the set, the third enumeration being different from the first enumeration.

11. The method of claim 10, wherein the third enumeration comprises a permutation of the first enumeration.

12. The method of claim 10, wherein the third enumeration differs from the first enumeration by at least one item.

13. The method of claim 10, wherein the third enumeration comprises the specific item.

14. The method of claim 8, wherein the collection is restricted to documents of a particular language.
